(19) United States
(12) Patent Application Publication
(10) Pub. No.: US 2011/0013378 A1
(43) Pub. Date: Jan. 20, 2011

(54) BACKLIT APPARATUSES AND METHODS THEREFOR

(75) Inventors: Emanuel H. Silvermint, Shoreview, MN (US); Daniel R. Pehrson, Baxter, MN (US); Varuni S. Novick, Eagan, MN (US); Karapet Sharlakian, Altadena, CA (US); Jay C. Lueck, Baxter, MN (US); James H. Bartel, Wayzata, MN (US); Dwight R. Hammermeister, Brainerd, MN (US)

Correspondence Address: SCHWEGMAN, LUNDBERG & WOESSNER, P.A., P.O. BOX 2938, MINNEAPOLIS, MN, 55402, US

(73) Assignee: ATEK Products, LLC, Brainerd, MN (US)

(21) Appl. No.: 12/818,374

(22) Filed: Jun. 18, 2010

Related U.S. Application Data
(60) Provisional application No. 61/218,684, filed on Jun. 19, 2009.

(51) Int. Cl. G09F 13/04; H01J 9/24

(52) U.S. Cl. 362/97.1; 445/23

(57) ABSTRACT

This document discusses, among other things, backlit apparatuses and methods therefor. In an example, an apparatus includes a backlit apparatus for controlling an end device. A housing has an opening in a front end of the housing. An actuation unit is attached to the housing. The actuation unit is coupled to the end device and configured to at least partially control the end device. A light source unit is disposed within the housing. The light source unit is configured to emit light within the housing. A light member is disposed at the opening in the housing. The light member includes properties configured to transmit the light emitted by the light source unit. The light source unit and the light member are configured to provide backlighting of the apparatus. In another example, a method includes cost-effectively providing backlighting to such an apparatus.

### RELATED APPLICATION

This patent application claims the priority benefit of U.S. Provisional Application Ser. No. 61/218,684, filed Jun. 19, 2009, and entitled “BACKLIT APPARATUSES AND METHODS THEREFOR”, the content of which is incorporated herein by reference in its entirety.

### BACKGROUND

Actuation devices, such as for automatic door actuation, include various styles and designs, and can include some form of printing, engraving, decal, painting, symbols, or other markings to indicate what the actuation device controls. Such actuation devices typically close or open a circuit to start or stop a mechanical device that performs an operation.

Such actuation devices and the markings thereof are typically intended to be readily identifiable to facilitate a user in locating the actuation device in order to use it to, for instance, open a door. Shape, size, and location of the actuation device further help a user to locate and identify the actuation device.

### OVERVIEW

The present inventors have recognized, among other things, that there exists a need for backlit apparatuses and methods therefor in order to call attention to the apparatus and designate the purpose of the apparatus. The present inventors have further recognized the need to manufacture such backlit apparatuses in a cost-effective manner so as to not be cost prohibitive to produce.

In some embodiments, an apparatus includes a backlit apparatus for controlling an end device. A housing has an opening in a front end of the housing. An actuation unit is attached to the housing. The actuation unit is coupled to the end device and configured to at least partially control the end device. A light source unit is disposed within the housing. The light source unit is configured to emit light within the housing. A light member is disposed at the opening in the housing. The light member includes properties configured to transmit the light emitted by the light source unit. The light source unit and the light member are configured to provide backlighting of the apparatus.

In Example 1, a backlit apparatus is configured to control an end device. The apparatus includes a housing. An actuation unit is attached to the housing. The actuation unit is coupled to the end device and configured to at least partially control the end device. A light source unit is disposed within the housing. The light source unit is configured to emit light within the housing. A light guide is attached to the housing. The light guide includes properties configured to transmit the light emitted by the light source unit. The light source unit and the light guide are configured to provide backlighting of the apparatus. The light guide is configured to propagate light in a plurality of modes.

In Example 2, the apparatus of Example 1 is optionally configured such that the properties include at least one of shape and size of the light guide.

In Example 3, the apparatus of one or more of Examples 1-2 is optionally configured such that the properties include optical properties of the light guide, wherein the optical properties include at least one of transmittance, haze, and translucency.

In Example 4, the apparatus of one or more of Examples 1-3 is optionally configured such that the light guide is configured to emit light of a substantially consistent brightness from a portion of the light guide.

In Example 5, the apparatus of one or more of Examples 1-4 is optionally configured such that the light source unit is disposed at least partially around the actuation unit.

In Example 6, the apparatus of Example 5 is optionally configured such that the light source unit is substantially U-shaped.

In Example 7, the apparatus of one or more of Examples 1-6 is optionally configured such that the light source unit includes a plurality of light sources attached to a circuit board.

In Example 8, the apparatus of one or more of Examples 1-7 is optionally configured such that the actuation unit is a push switch including a push plate adjacent the push switch.

In Example 9, a backlit apparatus is configured to control an end device. The apparatus includes a housing. An actuation unit is attached to the housing. The actuation unit is coupled to the end device and is configured to at least partially control the end device. A light source unit is disposed within the housing. The light source unit is configured to emit light within the housing. The light source unit is engaged with the actuation unit. A light filter is attached to the housing. The light filter includes properties configured to transmit the light emitted by the light source unit. The light source unit and the light filter are configured to provide backlighting of the apparatus.

In Example 10, the apparatus of Example 9 is optionally configured such that the properties include at least one of shape and size of the light filter.

In Example 11, the apparatus of one or more of Examples 9-10 is optionally configured such that the properties include optical properties of the light filter, wherein the optical properties include at least one of transmittance, haze, and translucency.

In Example 12, the apparatus of one or more of Examples 9-11 is optionally configured such that the light source unit is disposed at least partially around the actuation unit.

In Example 13, the apparatus of Example 12 is optionally configured such that the light filter is configured to emit light of a substantially consistent brightness from a portion of the light filter.

In Example 14, the apparatus of one or more of Examples 9-13 is optionally configured such that the light source unit includes a plurality of light sources attached to a circuit board.

In Example 15, the apparatus of one or more of Examples 9-14 optionally includes an elastic member configured to position the light source unit within the housing.

In Example 16, the apparatus of one or more of Examples 9-15 is optionally configured such that the actuation unit includes a touchless switch.

In Example 17, the apparatus of one or more of Examples 9-16 is optionally configured such that the light filter includes a recess configured to retain a decal therein. The recess is configured to provide a selected amount of light transmission through the decal to obtain a selected balance between the light transmission through the recess and the decal and through another portion of the light filter.

In Example 18, a method of cost-effectively providing backlighting to an apparatus includes selecting an apparatus to backlight. The apparatus is selected from at least a first apparatus and a second apparatus, wherein the first apparatus is configured differently from the second apparatus. A universal light source unit is attached within the selected apparatus. The light source unit is configured to provide backlighting of the selected apparatus. The light source unit is configured to universally fit and operate within either of the at least first and second apparatuses.

In Example 19, the method of Example 18 optionally is configured such that selecting an apparatus to backlight includes selecting either the first apparatus including a push switch or the second apparatus including a touchless switch.

In Example 20, the method of one or more of Examples 18-19 optionally includes attaching a light member to the selected apparatus. The light member includes properties configured to transmit light emitted by the light source unit. The light source unit and the light member are configured to provide the backlighting of the selected apparatus.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an exploded perspective view of a backlit apparatus according to some embodiments of the disclosed subject matter.

FIG. 2 is a cut-away partial side view of some components of the apparatus of FIG. 1, showing various modes of light propagation within the apparatus.

FIG. 3 is a cut-away partial side view of some components of the apparatus of FIG. 1, showing a mode of light propagation within the apparatus.

FIG. 4 is a cut-away partial side view of some components of the apparatus of FIG. 1, showing various modes of light propagation within the apparatus.

FIG. 5 is a cut-away partial side view of some components of the apparatus of FIG. 1, showing various modes of light propagation within the apparatus.

FIG. 6 is a cut-away partial side view of some components of the apparatus of FIG. 1, showing various modes of light propagation within the apparatus.

FIG. 7 is a perspective view of a component of the apparatus of FIG. 1.

FIG. 8 is a plan view of some components of the apparatus FIG. 1.

FIG. 9 is an exploded perspective view of a backlit apparatus according to some embodiments of the disclosed subject matter.

FIGS. 10A-10E are front, side, top, back, and front perspective views, respectively, of a component of the apparatus of FIG. 8.

FIG. 11 is a back perspective view of the component of FIG. 10.

FIG. 12 is a perspective view of assembly of some internal components of the apparatus of FIG. 8.

FIG. 13 is a block diagram of an example of a light source unit according to some embodiments of the disclosed subject matter.

FIG. 14 is a schematic of an example of a light source unit according to some embodiments of the disclosed subject matter.

FIG. 15 is a schematic of an example of a light source unit according to some embodiments of the disclosed subject matter.

### DETAILED DESCRIPTION

Current actuation devices include various shortcomings. For instance, current automatic door actuation devices commonly rely on shape, size, and markings to catch the eye of the user. Depending upon the location of and the background behind the actuation device, such actuation devices can be relatively difficult to locate and identify for its purpose.

The present inventors have recognized, among other things, that there exists a need for backlit apparatuses and methods therefor in order to call attention to the apparatus and designate the purpose of the apparatus. The present inventors have further recognized the need to manufacture such backlit apparatuses in a cost-effective manner so as to not be cost prohibitive to produce.

The subject matter described herein may take form in various components and arrangements of components, and in various procedures and arrangements of procedures. The simplified drawings are only for purposes of conveying the basic design intent and illustrating various examples of the invention and are not to be construed as limiting the invention.

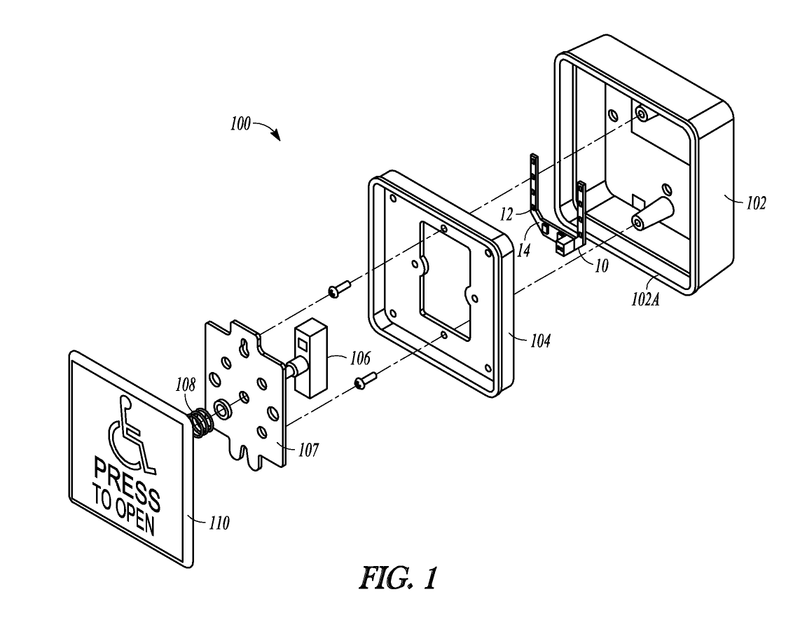

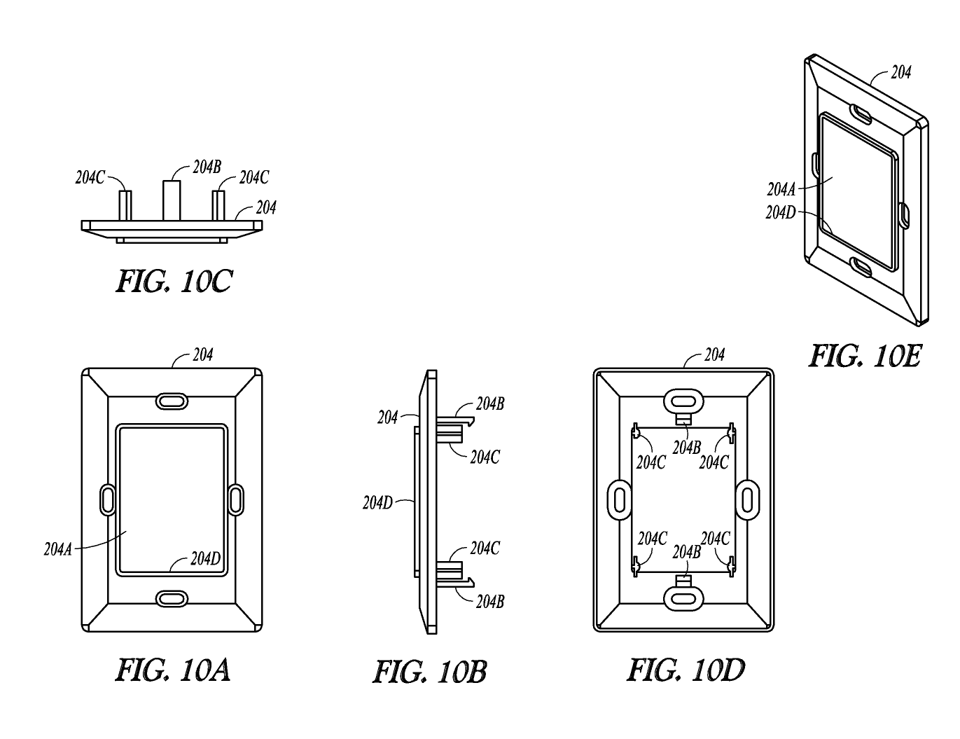

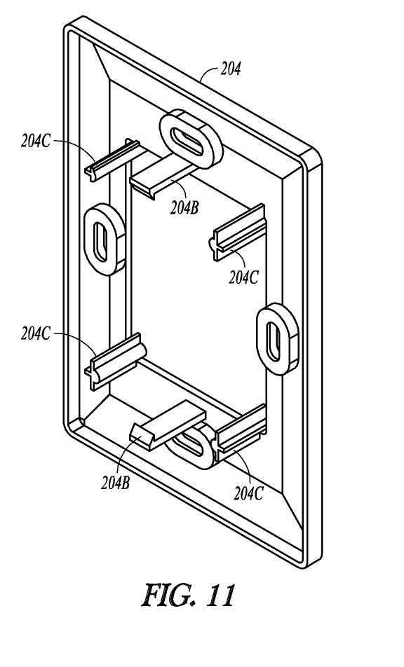

Referring initially to FIGS. 1-15, several examples of backlit apparatuses are shown for controlling an end device. For example, the apparatuses can include various types of switches such that actuation of the switch causes closing or opening of a circuit to control at least an aspect of operation of an end device. Examples of end devices include, but are not limited to, automatic doors, machines, elevators, escalators, automatic ramps, and various other devices. For instance, with an automatic door, a backlit switch in accordance with one or more embodiments of the disclosed subject matter can be actuated to start an electrical actuator to cause opening or closing of the door. The switch can be electrically coupled to the circuit of the door actuator or it can be wirelessly coupled to a switch in the circuit of the door actuator. Moreover, although the description below primarily focuses on switches for automatic doors, this is only intended to be exemplary and is not intended to be limiting. As stated above, such switches can be implemented with respect to numerous types of devices. Furthermore, the principles of backlighting described herein can apply equally to other types of devices, including, but not limited to, placards, signs, keypads, security pads (keycard receivers, for instance), and the like.

Referring now to FIGS. 1, 7, and 8, in some examples, a backlit apparatus 100 for controlling an end device includes a housing 102. In an example, the housing 102 includes an opening 102A in a front end of the housing 102. The housing 102 can be configured to surface mount on a wall, for instance, or other structure to provide for a backlit apparatus 100 that can be installed on a surface of the structure. The housing 102 can alternatively be configured to mount within a wall or other structure to provide a backlit apparatus 100 that is substantially flush with the wall or other structure. In an example, the housing 102 can include a standard electrical box that can be used to mount the apparatus 100 flush or substantially flush with the wall or other structure.

In an example, an actuation unit 106 is attached to the housing 102. In an example, the actuation unit 106 is disposed at least partially within the housing 102. In other examples, the actuation unit 106 is fixed with respect to the housing 102, regardless of whether the actuation unit 106 is disposed within or outside of the housing 102. In an example, the actuation unit 106 is a push switch 106 that includes a push plate 110 adjacent thereto to allow a user to push the push plate 110 in order to actuate the push switch 106. In various examples, the push plate 110 can be attached to the push switch 106 or can be only abutting the push switch 106. In an example, the push switch 106 further includes a spring 108 to bias the push plate 110 (and the push switch 106) toward an unactuated position. In some examples, the push switch 106 is coupled to the end device and configured to at least partially control the end device. In various examples, the push switch 106 is electrically, wirelessly, or otherwise coupled to the end device.

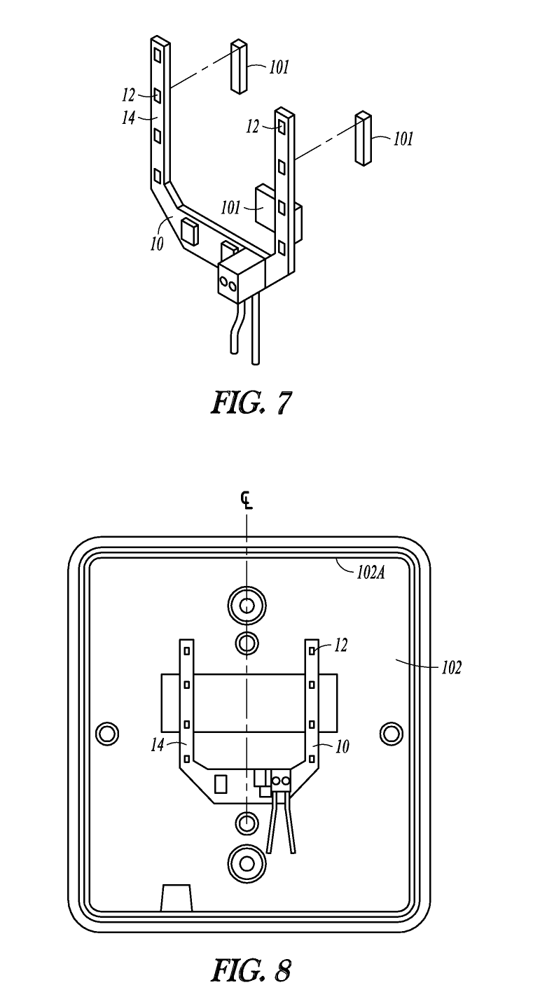

In an example, a light source unit 10 is disposed within the housing 102. The light source unit 10 is configured to emit light within the housing 102. The light source unit 10, in some examples, includes a plurality of light sources 12 attached to a circuit board 14. In another example, the light source unit 10 includes one light source 12. It is contemplated that the one or more light sources 12 include any type of light producing element or device including, but not limited to a light emitting diode (LED), an LED array, a high intensity LED, a fiber optic light source, an incandescent light, a light emitting polymer (LEP) (including both an organic LED (OLED) or a polymer LED (PLED)), a LEP array, an electroluminescent illumination panel, any other type of light source. In one example, the light source unit 10 is U-shaped and is attached to a back surface of the housing 102 so that the one or more light sources 12 emit light at least toward the opening 102A of the housing 102 (see FIGS. 1 and 8). In an example, the light source unit 10 is attached to the housing 102 using one or more tape segments 101 (see FIG. 7). In another example, an envelope or holder is attached to the housing 102 (for instance, the bottom surface of the housing 102) to accept the light source unit 12 for attachment of the light source unit 12 within the apparatus 100. In a further example, the envelope or holder can be transparent, translucent, colorless, or colored. In still another example, clear or colored tubing (for instance, PVC tubing) is attached to the housing 102 (for instance, the bottom surface of the housing 102) to accept the light source unit 12 for attachment of the light source unit 12 within the apparatus 100. In other examples, the light source unit 10 is attached to the housing 102 in other manners including, but not limited to, glue or other adhesives, screws or other fasteners, or retention within mating structures of the housing (for instance, detent arrangements, hook structures, and the like). In an example, the light source unit 10 is substantially the same size as the push plate 110. In another example, the light source unit 10 is smaller than the push plate 110. In still another example, the light source unit 10 is larger than the push plate 110.

In some examples, the apparatus 100 further includes a light member 104 attached to the housing 102. In an example, the light member 104 is disposed at the opening 102A in the housing 102. The light member 104 can be attached to extend outwardly from the opening 102A, to partially extend outwardly from the opening 102A, or to be completely retained within the housing 102A (at or below the opening 102A). In one example, the light guide member 104 forms an attachment surface for a back plate 107, to which the actuation unit 106 is attached. The back plate 107 can also be reflective to reflect light within the apparatus 100.

The light member 104 in some examples is a light guide 104 that includes various properties that allow the light guide 104 to transmit, diffuse, direct, disseminate, reflect, and/or otherwise cause light to pass through, away from, and/or out of the light guide 104 in a desired manner. For instance, the properties can include physical properties of the light guide 104, such as size, shape, and geometries of the various surfaces of the light guide 104. The properties, in other examples, can include optical properties of a material of the light member 104. In further examples, the optical properties include at least one of transmittance, haze, and translucency. For the purposes of this description, the following definitions are offered:

Transmittance: the percent of incident light that is able to pass through a material. The higher the transmittance value, the more transparent a material is. One way to measure the clarity and/or transparency is by measuring opacity by the percent transmission (% T) of light through an article having a defined thickness. The higher the % T, the less opaque the article is and the more light passes through the article.

Haze: the percent of transmitted light that is scattered more than 2.5° from the direction of the incident beam. Materials with haze values greater than 30% are considered diffusing. When measuring haze, the percentage of light diffusely scattered is compared to the total.

Translucency: translucence is defined herein as a combination of both haze and luminous transmittance of visible light. “Translucent” is defined herein to mean that the sheet or article has light transparency in the range from 2 to 98% and haze in the range from 0.5 to 95%, preferably haze in the range from 1 to 90%.

Other optical properties can include refractive index and/or surface reflectance. Further factors that can influence the manner in which the light guide 104 transmits light includes distance to the one or more light sources 12, light incident angle, and push switch 106 design and dimensions. In an example, the light source unit 10 and the light member 104 are configured to provide backlighting of the apparatus 100.

In various examples, the light guide 104 can be formed of a translucent resin, which allows light to be transmitted and dispersed to a some extent therethrough. The material of the light guide 104 can be selected from various plastic substances in clear, tints, and opaque colors. In many situations, the relative low cost of thermoforming provides manufacturing cost advantages. Yet injection molding is the most common method of part manufacturing into ready articles. An example of a plastic for the light guide 104 is polycarbonate (“PC”), which is known for its temperature resistance, impact resistance, and high light transmittance. PC is almost completely transparent throughout the entire visible spectrum. In an example, Lexan brand is a durable PC resin thermoplastic. Injection moldable LEXAN, grade 920A resin available from SABIC Innovative Plastics, is a medium viscosity flame retardant grade plastic, especially suitable for electrical applications. Another thermoplastic suitable for practicing the present invention is clear acrylonitrile butadiene styrene (“ABS”); ABS is another common thermoplastic used to make light, rigid, molded products.

Optionally, in other examples, the light guide 104 can contain, as a non-limiting example, effective suitable amounts of additive material. The typical difference in refractive indexes between the light transmissive resin and the light transmissive diffusing material is in the range of 5 to 25%. Light-scattering agents such as calcium carbonate, titanium oxide or dioxide, zinc oxide or sulfide, lead carbonate, silicon nitride, barium sulfate, carbon black, glass beads, or particles of polycarbonate, silica, polyethylene, polystyrene or silicone resins, cured melamine resin, cross-linked or acrylic polymers, polyvinyl chloride, or the like can be used.

In various examples, the light guide 104 can be formed with one or more combinations of polycarbonate ingredients. Examples of such combinations include a polyolefin, an aromatic polycarbonate, and a cycloaliphatic polyester.

In an example, by forming the light guide 104 from resin loaded with melamine beads, for instance having slightly over 1 micron in average particle diameter, haze value could be increased 500%, to about 60% with load increase less than 7 times by weight, while transparency in visible light would degrade only about 11%. If transparency degradation is not an issue, only 0.2% (by weight) melamine beads load could provide over 40% haze with over 45% transparency.

In still further examples, the light guide 104 can be formed from a PC composition (for example, ABS) having impact modifiers added thereto.

In an example, a hazing additive range of the material of the light guide 104 can be from 0.1% to 20% of the total of the composite weight. In another example, the hazing additive range can be from 0.2% to 20%. In still another example, the hazing additive range can be from 0.5% to 10%. In yet another example, the hazing additive range can be from 1.5% to 4%.

In an example, relatively good light diffusion can be obtained by pigment loading in the range 1.5 to 3% by weight. In this example, the major constituent of the materials of the light guide 104 is Lexan 124R resin, with refractory index 1.586, haze 1.0%, and visible light transparency 88.0%. The light transparency of the loaded test sample was in the range 30-40%. The material is available from SABIC Innovative Plastics Canada, Cobourg, Ontario, formerly GE Plastics.

It is noted that the term “translucent” does not require that a whole surface or an article itself is transparent and portions of the article may be transparent or opaque, for example to serve a function or to form a decorative pattern.

In still another example, the light guide 104 can be injection-molded from Acrylonitrile Butadiene Styrene (“ABS”) resin, more specifically, Chi Mei Corporation's Polylacâ® PA-758. In an example, such an arrangement features 90.0% light transmittance and 4.0% haze. The material is available from a distributor Entec Polymers, LLC., or from Entec Logistics, Plainfield, Ill.

In other examples, the light guide 104 can include at least one surface having an altered roughness or texturing characteristic, such as matte finish, to change optical properties by altering light incidence, reflection, and propagation in the medium. Molding of certain polymers, for example, ABS, creates anisotropy as revealed by electron microscopy. A textured pattern can be complex, aperiodic, haircell-type, prismatic, or have a varying composition. In an example, at least one surface of the light guide 104 can be treated to obtain surface roughness in the range of 0.1 to 20 microns. In a further example, at least one surface of the light guide 104 can be treated to obtain surface roughness in the range of 0.2 to 4 microns. In various examples, the surface alteration can be achieved by different processes, including, but not limited to, addition of cross-linked particles, embossing, sand blasting, acid etching, or by injection molding where a mold would be designed accordingly. In an example, a mold can be processed to achieve a desired roughness finish, for example, by etching or various precision machining, including, electro discharge machining.

In other examples, the light guide 104 can include a layer with a different refractive index, for example, using a paint containing melamine beads, to alter the light diffusing property of at least a portion of the light guide104. In further examples, a light diffusing layer could be formed using UV irradiation, or light can be scattered using a layer of dots that can be printed on a surface of the light guide 104.

In another example, the light guide 104 can include application of a film, for example by lamination or adhesion process. In certain examples, translucent, matte-finish DFxx diffuser films are 70 to 250 micron thick and provide 79 to 88% haze with 99 to 87% light transparency. These products are available from Grafix® Plastics, Cleveland, Ohio. Accordingly, the light guide 104, in some examples, can include a light diffusing layer laminated or otherwise affixed to at least a surface of the light guide 104, for instance a surface facing the one or more light sources 12.

In an example, a reflective layer or plate can be employed within the apparatus 100 to direct an increased amount of light into the light guide 104. In one example, a reflective coating can be accomplished by vacuum evaporation of aluminum using radio frequency sputtering. In an example, a thickness of the coating is between 20 nm and 1 micron.

In some examples, a color of light emanating from the apparatus 100 can be selected, for instance, to impart a desired visual appearance to the apparatus. Various examples include employing one or more desired monochromatic light sources. In this way, various light sources can be used, the various light sources providing white or colored spectra of visible light. In other examples, if a spectrum of the one or more light sources 12 is wide or polychromatic, a color filter, such a layer or a plate, can be employed to accentuate a specific color. In another example, the color filter can include a flat colored plastic sheet or strip or colored tubing. In a further example, the apparatus includes two or more differently colored light sources 12 or two or more differently colored filters for the light sources 12. In still further examples, the light guide 104 can be molded from a composite material with a colorant additive.

The light guide 104 can include various configurations, shapes, sizes, etc. to emit light in a desired manner. For instance, in an example, only a portion of the light guide 104 is exposed to emit light outside of the apparatus 100, with the remainder of the light guide 104 being disposed within the housing 102 and/or behind the push plate 110. In various examples, the size and shape of the exposed portion of the light guide 104 can be tailored according to the amount and direction of emitted light that is desired. In other examples, the entire light guide 104 could be exposed, if desired. In some examples, the light guide 104 is configured to emit light of a substantially consistent brightness from one or more exposed portions. The size and shape of the light guide 104 and/or the exposed portion(s) of the light guide 104 can also be configured, in various examples, to give a desired range and/or angle of visibility of the light emitted from the light guide 104.

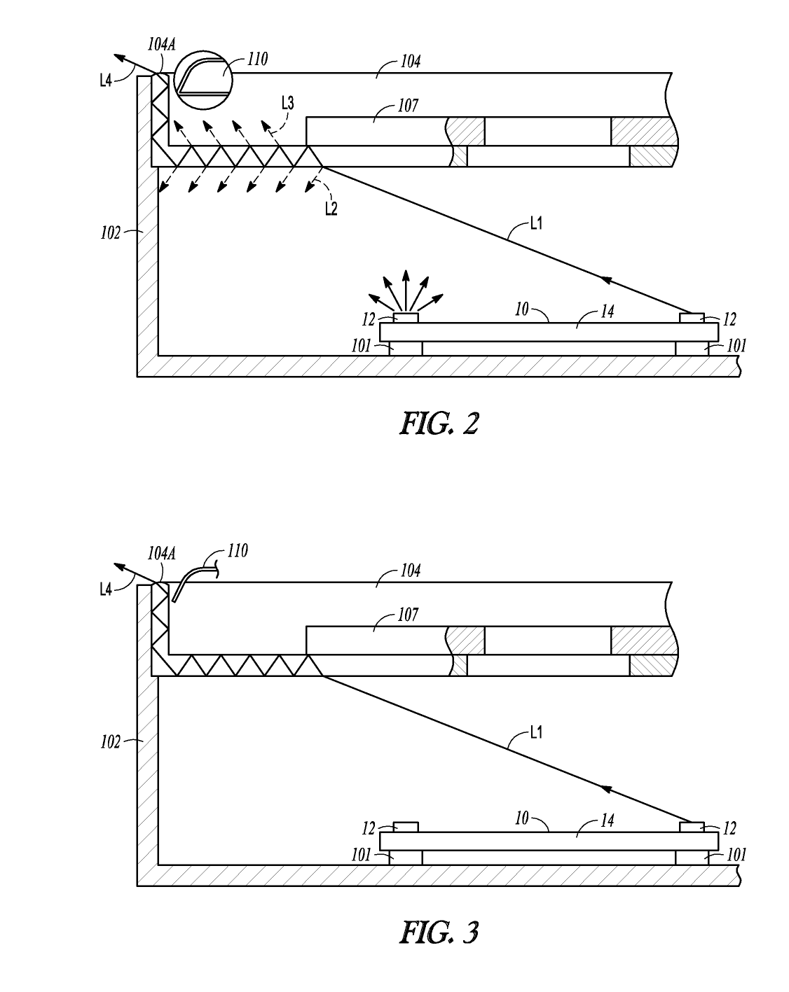

Referring to FIGS. 2-6, in various examples, the light guide 104 is configured to propagate light in a plurality of modes. It is contemplated that the light guide 104 propagate light in one or more of the plurality of modes during illumination of one or more of the light sources 12. In FIG. 2, in an example, one mode of light propagation includes light at L1 emitted from one of the light sources 12, which is internally reflected within a horizontal surface of the light guide 104. An amount of light L2 is emitted from a bottom surface of the horizontal surface of the light guide 104 and retained within the housing 102, while an amount of light L3 is emitted from a top surface of the horizontal surface of the light guide 104. The amount of reflected light can vary based on at least surface properties of the light guide 104 (for instance, texture, incidence angle, etc.). An amount of light continues to be internally reflected within the horizontal surface of the light guide 104 to a side vertical surface of the light guide 104, where it undergoes total internal reflection (TIR) and is ultimately emitted at L4 from a curved, lens-like top edge 104A of the light guide 104 disposed around a periphery of the push plate 110 (a segment of which is shown in FIG. 2). In an example, the curved top edge 104A can allow light to be seen from an angle and/or from a side of the apparatus 100. In this way, light from the backlit apparatus 100 can be discerned from various angles of viewing, such as from the side of the apparatus 100. In FIG. 3, in another example, a similar mode of light propagation is shown where the light is entirely internally reflected within the light guide 104 and is ultimately emitted from the curved top edge 104A of the light guide 104.

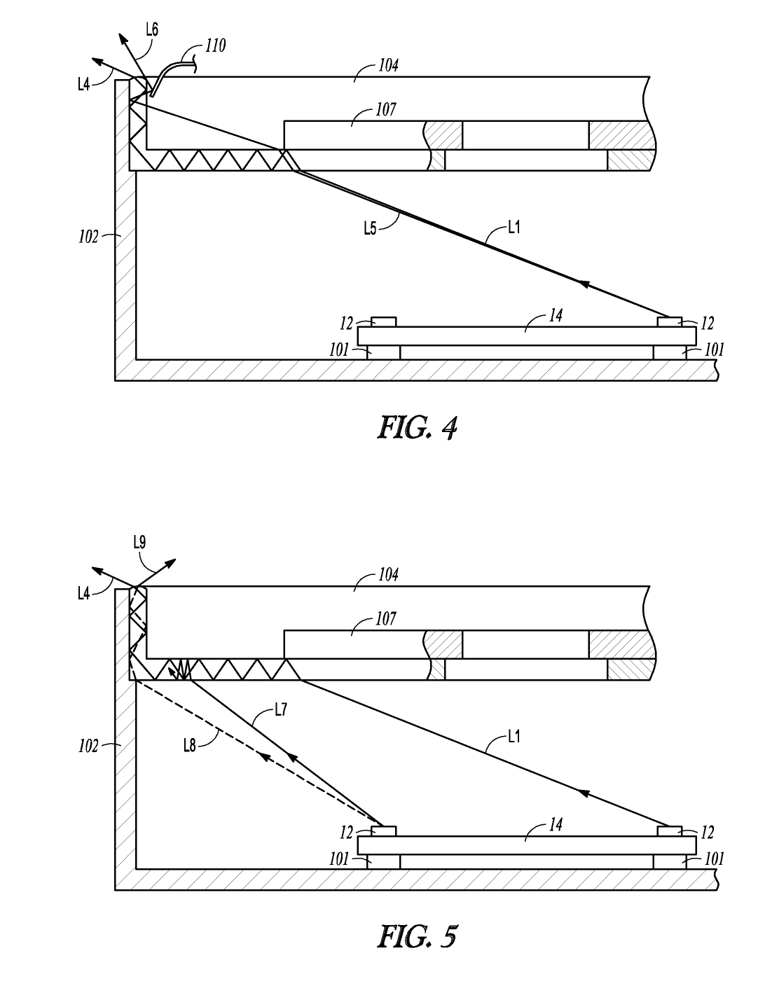

In FIG. 4, in still another example, another mode of light propagation includes light emitted at L5 from one of the light sources 12 which is transmitted through or otherwise interfaces the horizontal surface(s) of the light guide 104 and re-enters the light guide 104 through the side surface of the light guide 104. The light re-entering the light guide 104 can be transmitted directly into the light guide 104 from the horizontal surface of the light guide 104. In other examples, the light can be reflected off of another surface (for instance, off of the push plate 110 or off of another surface of the apparatus 100 (for instance, a surface of the light guide 104, a surface of the housing 102, or any other surface of the apparatus 100) prior to re-entering the light guide 104. The light then re-exits the side surface of the light guide 104 and is reflected off of a portion of the push plate at L6. In FIG. 5, in another example, another mode of light propagation includes light at L7 emitted from another of the light sources 12 which is internally reflected within the light guide 104 and ultimately can be emitted from the light guide 104, for instance at the top edge 140A. Light at L8 is internally reflected (in one example, totally internally reflected) within the side surface of the light guide 104 and is ultimately emitted at L9 through the top edge 104A at a different angle from the light at L4.

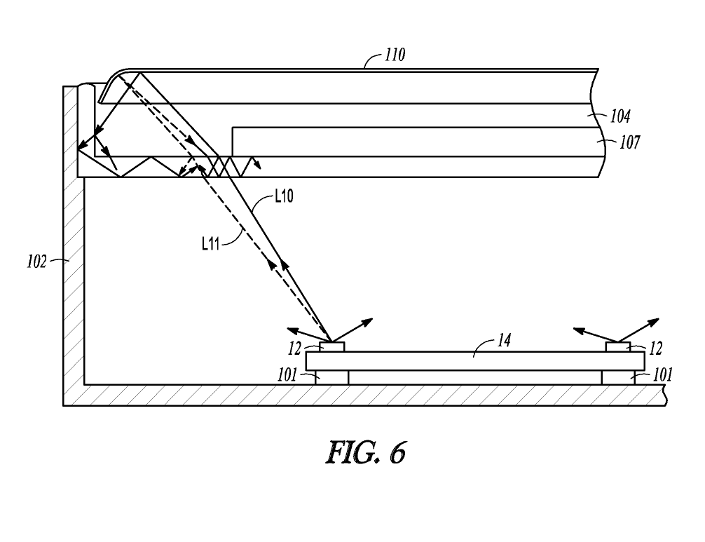

In FIG. 6, in another example, light is emitted at L10 from one of the light sources 12 and is transmitted through the horizontal surfaces or interfaces of the light guide 104 and reflects off of a bottom surface of the push plate 110. The reflected light then partially reflects off of the side surface of the light guide 104 and re-enters the horizontal surface within the light guide 104 while the remainder of light re-enters the side surface of the light guide 104 to be internally reflected within the light guide 104. In an example, the remainder of light re-enters the side surface of the light guide 104 at the less than critical angle to be reflected again at the horizontal surface at the more than critical angle to undergo the TIR within the horizontal part of the light guide 104, eventually exiting the right side wall (not shown) of light guide 104. In this example, the light guide 104, in cooperation with the push plate 110 and/or the light sources 12, has a property to achieve a mode transformation to TIR along a light path. Light at L11 is emitted from one of the light sources 12 and is transmitted through the horizontal surface or interfaces of the light guide 104. The light then reflects off of a bottom of a side surface of the push plate 110 and re-enters the horizontal surface of the light guide 104 to be partially internally reflected within the light guide 104.

It should be understood that there are an infinite number of light propagation modes depending upon the angle that light is emitted from the light source 12 and from which light source 12 light is emitted and further depending upon the geometry and optical properties of the light guide 104. Different optical properties of the material of the light guide 104 will cause different angles of refraction and amounts of light reflected, which will change the light paths of the modes. It should be further understood that, although some modes of light propagation are shown in FIGS. 2-6, not all of the possible modes are shown herein. For instance, some modes of light propagation include light reflected off the back plate to remain within the housing 102. In some examples, the properties of the light guide 104 and/or the various modes of light propagation of the light guide 104 allow for a relatively large range of distances and/or angles between the light guide 104 and the one or more light sources 12. The range increase, in turn, is important for the methods taught in the present application and aids in affording a designer more design options to consider. Further, a substantially more consistent brightness from a portion of the light guide 104 can be achieved for a given distance between the one or more light sources 12 and the light guide 104.

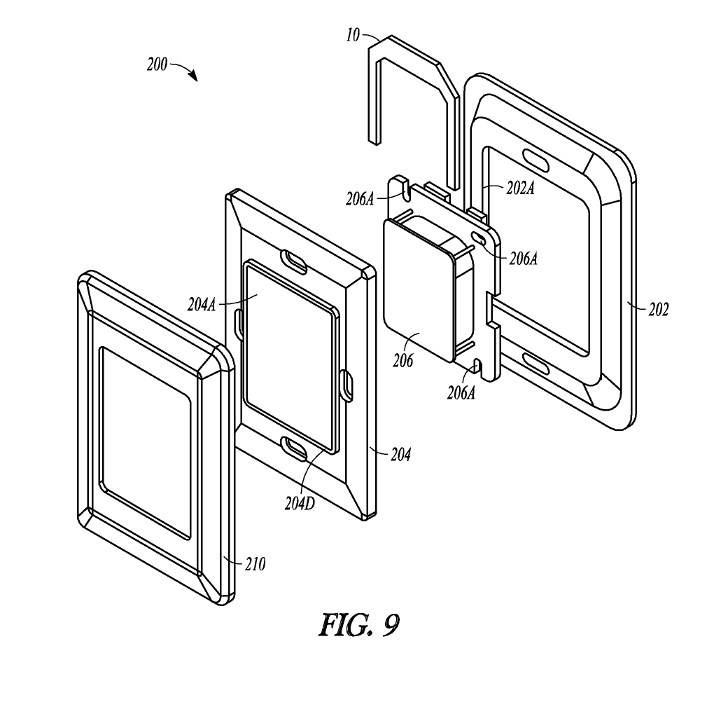

Referring to FIGS. 9-12, in some examples, a backlit apparatus 200 for controlling an end device includes a housing 202. In an example, the housing 202 includes an opening 202A in a front end of the housing 202. The housing 202 can be configured to surface mount on a wall, for instance, or other structure to provide for a backlit apparatus 200 that can be installed on a surface of the structure. The housing 202 can alternatively be configured to mount within a wall or other structure to provide a backlit apparatus 200 that is substantially flush with the wall or other structure. For instance, in an example, the backlit apparatus 200 can be mounted substantially flush with the wall or other structure using a standard electrical box for the housing 202.

In an example, an actuation unit 206 is attached to the housing 202. In an example, the actuation unit 206 is disposed at least partially within the housing 202. In other examples, the actuation unit 206 is fixed with respect to the housing 202, regardless of whether the actuation unit 206 is disposed within or outside of the housing 202. In some examples, the actuation unit 206 is a touchless switch 206. In other examples, although the touchless switch 206 is described below, it should be understood that other types of switches can be used instead of or in addition to the touchless switch 206, such as touch switches (for instance, capacitance-based switches) or other switches.

In an example, the touchless switch 206 includes contact-free wall switch that is based on Doppler effect motion detection in the X band microwave range. In various other examples, the touchless switch 206 includes a motion detector including one or more passive infrared sensors (“PIR”), one or more active ultrasonic sensors, one or more active microwave sensors, or a combination of different sensor types. In one example, the touchless switch 206 includes microwave motion sensors and modules, which can be based on Doppler effect and operate in the super high frequency (“SHF”) range of 3 to 30 GHz. Some sensors and modules can be available in the industrial, scientific, and medical (“ISM”) radio bands, as some ISM bands are also SHF bands. These sensors and modules can use region-specific, designated frequencies in the Institute of Electrical and Electronics Engineers (“IEEE”) K band (18 to 27 GHz), X band (8 to 12 GHz), or C band (4 to 8 GHz). In another example, the touchless switch 206 can include one or more microwave motion sensors.

In some examples, the touchless switch 206 is coupled to the end device and configured to at least partially control the end device. In various examples, the touchless switch 206 is electrically, wirelessly, or otherwise coupled to the end device.

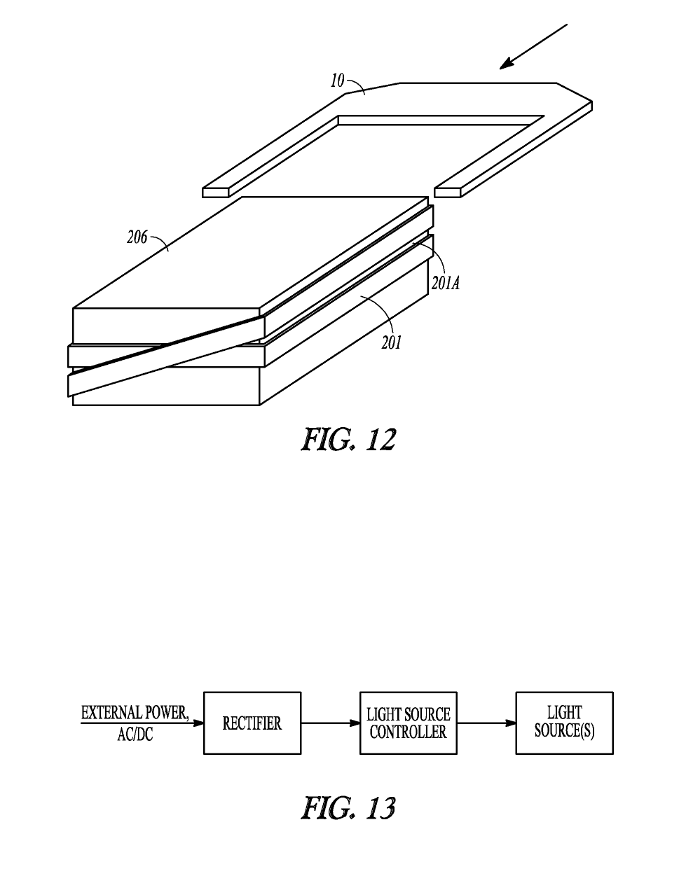

In an example, the light source unit 10 (as described above) is disposed within the housing 202. The light source unit 10 is configured to emit light within the housing 202. The light source unit 10, in some examples, includes a plurality of light sources 12 attached to a circuit board 14. In another example, the light source unit 10 includes one light source 12. It is contemplated that the one or more light sources 12 include any type of light producing element or device including, but not limited to a light emitting diode (LED), an LED array, a high intensity LED, a fiber optic light source, an incandescent light, a light emitting polymer (LEP) (including both an organic LED (OLED) or a polymer LED (PLED)), a LEP array, an electroluminescent illumination panel, any other type of light source. In one example, the light source unit 10 is U-shaped and is attached to an exterior of the touchless switch 206. In a further example, the light source unit 10 is disposed at least partially around the exterior of the touchless switch 206. For instance, as shown in FIG. 12, the U-shaped light source unit 10 can be disposed partially around the touchless switch 206, such that legs of the light source unit 10 slidingly engage opposite sides of the touchless switch 206 and a center portion of the light source unit 10 abuts an end of the touchless switch 206. In other examples, the light source unit 10 can be disposed under and/or over the touchless switch 206, either instead of or in addition to being mounted around the touchless switch 206. In another example, the light source unit 10 can be integrated with a portion of the touchless switch 206, for instance with a printed circuit board thereof. In another example, components (for instance, the light source(s) 12) are included integrally with the touchless switch 206, such that no separate circuit board 14 is needed. When attached to the touchless switch 206, in some examples, the light source unit 10 is configured so that the one or more light sources 12 emit light at least toward or through the opening 202A of the housing 202 and/or through the light filter 204.

In an example, an elastic member 201 can be used to position the light source unit 10 within the housing 202. That is, referring to FIG. 12, the elastic member 201 (for instance, a rubber band) is wrapped around the exterior of the touchless switch 206 so that a gap 201A is formed between windings of the elastic member 201. The light source unit 10 can then be slidingly engaged between windings of the elastic member 201. In this example, the elastic member 201 can be relatively easily positioned on the touchless switch 206 to properly position the light source unit 10 within the apparatus 200. The elastic member 201 can also function to space the light source unit 10 away from any surfaces which might act to short out or otherwise damage the light source unit 10. In another example, the elastic member 201 can function to control proximity of the light source unit 10 to a light guide 204, as described below. In an example, the elastic member 201 provides for cost-effective attachment of the light source unit 10 within the apparatus 200. In other examples, various spacers can be used to position and space the light source unit 10 within the apparatus 200. Various examples of spacers include PVC tubing, nylon wire ties or plastic straps (zip ties, for instance), etc. disposed around each of the legs of the light source unit 10 at one or more locations along each of the legs.

Referring to FIGS. 9-11, in some examples, the apparatus 200 further includes a light member 204 attached to the housing 202. In an example, the light member 204 is disposed at the opening 202A in the housing 202. In other examples, the housing 202 does not include an opening 202A at the front end of the housing 202, but instead includes a closed front end surface, for instance that allows at least some light from the light source unit 10 to pass therethrough. The light member 204, in an example, can be made by injection molding. In an example, the light member 204 is attached at a front face of the housing 202 to extend outwardly from the front face of the housing 202. In some examples, the light member 204 is configured to receive the touchless switch 206 to attach the touchless switch 206 to the apparatus 200. In an example, the light member 204 includes one or more attachment members 204B that are configured to attach to and/or retain the touchless switch 206. In one example, the one or more attachment members 204B include hooks 204B configured to engage a portion of the touchless switch 206. In other examples, other attachment members are contemplated. In some examples, the light member 204 includes alignment and/or orientation keys 204C extending from a back surface of the light filter 204, which mate with corresponding holes 206A within the touchless switch 206. In this way, the touchless switch 206 can be properly retained and aligned within the light member 204.

The light filter 204 can include various configurations, shapes, sizes, etc. to emit light in a desired manner. For instance, in an example, only a portion of the light filter 204 is exposed to emit light outside of the apparatus 200, with the remainder of the light filter 204 being disposed within the housing 202. In various examples, the size and shape of the exposed portion of the light filter 204 can be tailored according to the amount and direction of emitted light that is desired. In other examples, the entire light filter 204 could be exposed, if desired. In some examples, the light filter 204 is configured to emit light of a substantially consistent brightness from one or more exposed portions. The size and shape of the light filter 204 and/or the exposed portion(s) of the light filter 204 can also be configured, in various examples, to give a desired range and/or angle of visibility of the light emitted from the light filter 204. In some examples, the light filter 204 is configured to propagate light in a plurality of modes, in a manner similar to that discussed above with respect to the light guide 104. In some examples, the properties of the light filter 204 and/or the various modes of light propagation of the light filter 204 allow for a relatively large range of distances and/or angles between the light filter 204 and the one or more light sources 12. The range increase, in turn, is important for the methods taught in the present application and aids in affording a designer more design options to consider. Further, a substantially more consistent brightness from a portion of the light filter 204 can be achieved for a given distance between the one or more light sources 12 and the light filter 204.

In an example, the keys 204C and attachment members 204B allow for proper orientation of the touchless switch 206 and the light source unit 10 with respect to a recess 204A in the light member 204. In an example, the recess is configured to retain a decal, sign, etc. therein for conveying information, such as instructions, directions, purpose of the apparatus 200, labels, etc., to a user. In an example, the recess 204A is configured to provide a selected amount of light transmission through the decal or other information to obtain a selected balance between the light transmission through the recess 204A and the decal and another portion of the light member 204, for example, a frame 204D (described below) or some other portion of the light filter 204. In one example, the recess 204A of the light filter 204 is thinner under the placement of instruction label area to balance the light emanating through the recess 204A and perimeter framing (for instance, the frame 204D) of the recess 204A. In some examples, for instance, when the backlit apparatus 200 is used for a sign or other device for conveying information, the touchless switch 206 or other actuation unit 206 can be eliminated from the apparatus 200. In some examples, the light filter 204 includes a frame 204D or other protrusion to propagate and/or emit light. In an example, the frame 204D includes a curved, lens-like edge to emit light in various angles therefrom. In this way, light from the backlit apparatus 200 can be discerned from various angles of viewing, such as from the side of the apparatus 200.

In another example, the recess 204A can be blank (for example, no decal), absent (for instance, the light filter 204 need not include a recess 204A), or have at least one of an operating symbol, a picture, a sign, a message, a pattern of alphanumeric characters, and/or a display. In other examples, an insignia can be embossed, imprinted, engraved, stamped on or in, inked in, or otherwise optically contrasted with the light filter 204, on a front and/or back surface of the light filter 204.

The light member 204 in some examples is a light filter 204 that includes various properties that allow the light filter 204 to transmit, diffuse, direct, disseminate, reflect, and/or otherwise cause light to pass through, away from, and/or out of the light filter 204 in a desired manner. For instance, the properties can include physical properties of the light filter 204, such as size, shape, and geometries of the various surfaces of the light filter 204. The properties, in other examples, can include optical properties of a material of the light filter 204. In further examples, the optical properties include at least one of transmittance, haze, and translucency. Various materials and properties thereof are discussed above in detail with respect to the light guide 104 and are equally applicable with respect to the light filter 204. In one example, the light filter 204 is an injection-molded faceplate made from Polycarbonate Lexan 920A resin that features 85.0% light transmittance and 1.0% haze. In this example, the light filter 204 can include a label with a symbol accompanied by a mnemonic instruction, where the light filter 204 can act as a light diffuser/filter in the area under the label. In an example, particle-loading of the material of the light filter 204 can result in to improved light intensity and distribution, resulting in modified light transparency in the range between 5.5 to 7% on the frame surrounding the label area. In one example, to balance attenuation of the light due to the optical density of the employed label, the recess 204A can be sufficiently thinner to include 20-25% higher light transparency than the transparency value of the remainder (or frame) of the light filter 204.

In some examples, the apparatus 200 includes a cover plate 210 that at least partially covers the light filter 204. In one example, the cover plate 210 is substantially opaque, such that the cover plate 210 substantially blocks light emitted from the light filter 204 except the light emitted from the recess 204A (in some examples, through the decal or other information display) and/or the frame 204D. In an example, the cover plate 210 is substantially transparent. In other examples, the cover plate 210 can include various materials with various optical properties or colors, in manners similar to those described above. In one example, the cover plate 210 protects the decal or other information placed in the recess 204A or otherwise associated with the light filter 204. In another example, the cover plate 210 snaps onto the light filter 204. In one example, the cover plate 210 and the light filter 204 include mating tabs and slots for engagement. It is contemplated that the cover plate 210 can be attached to the light filter 204 in other ways, including, but not limited to, screws or other fasteners. In other examples, the cover plate 210 and the light filter 204 can be combined into a single article of manufacture or the cover plate 210 can be eliminated. If a label or decal is to be used with one of these examples, the label or decal can include adhesive or be attached in another way to one of the front and back surfaces of the light filter.

In some examples, the light filter 204 can include mounting places to accommodate screws for mounting the touchless switch 206 onto (or flush with) a surface for a user to operate the apparatus 200 to trigger an event such as a door opening, etc. In another example, the light filter 204 can include a protruding rim that can be used to define a position of the cover plate 210. In some examples, the protruding rim can include the frame 204D that can be used to emit light therefrom, as described above, for instance, to help define the operating space of the touchless switch 206. In a further example, a height of the rim can be flush with a front surface of the cover plate 210.

In some examples, the touchless switch 206 can operate in at least two different modes, including a “switch” (toggle) mode and a “sense” mode (hold—‘delayed door closing.’) In some examples, the touchless switch 206 includes adjustable sensing field distance and hold time.

In some examples, the apparatus 200 can provide for touchless activation of automatic doors, lighting controls, or call points. In one example, the apparatus 200 can be used in sterile environments, such as operating or clean rooms. In other examples, the apparatus can provide a hygienic switch for many different applications. Some applications of the apparatus 200 include, but are not limited to, clean rooms, pharmaceutical applications, rest rooms, food processing locations, restaurants, physicians' offices, medical facilities, semiconductor facilities, hospitals and clinics, and anywhere hygiene is desirable and/or important.

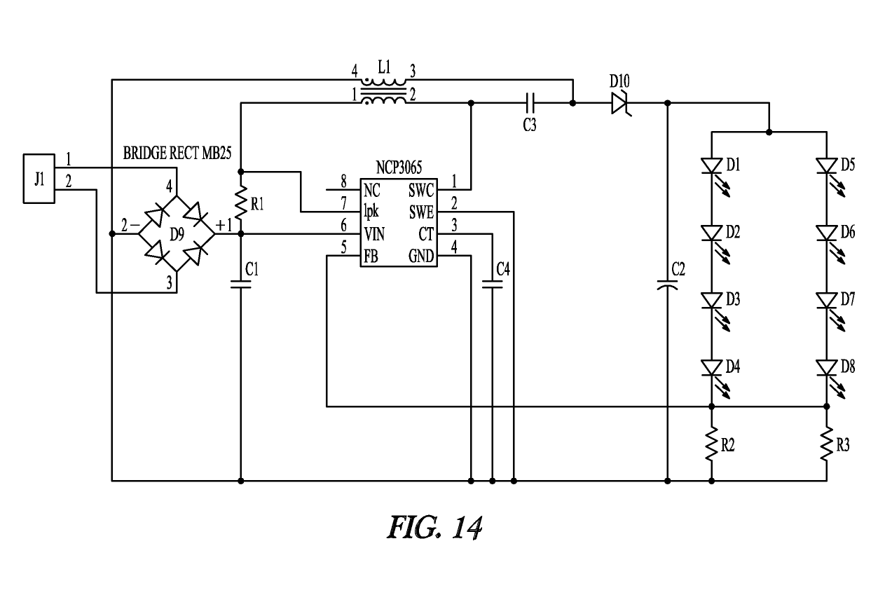

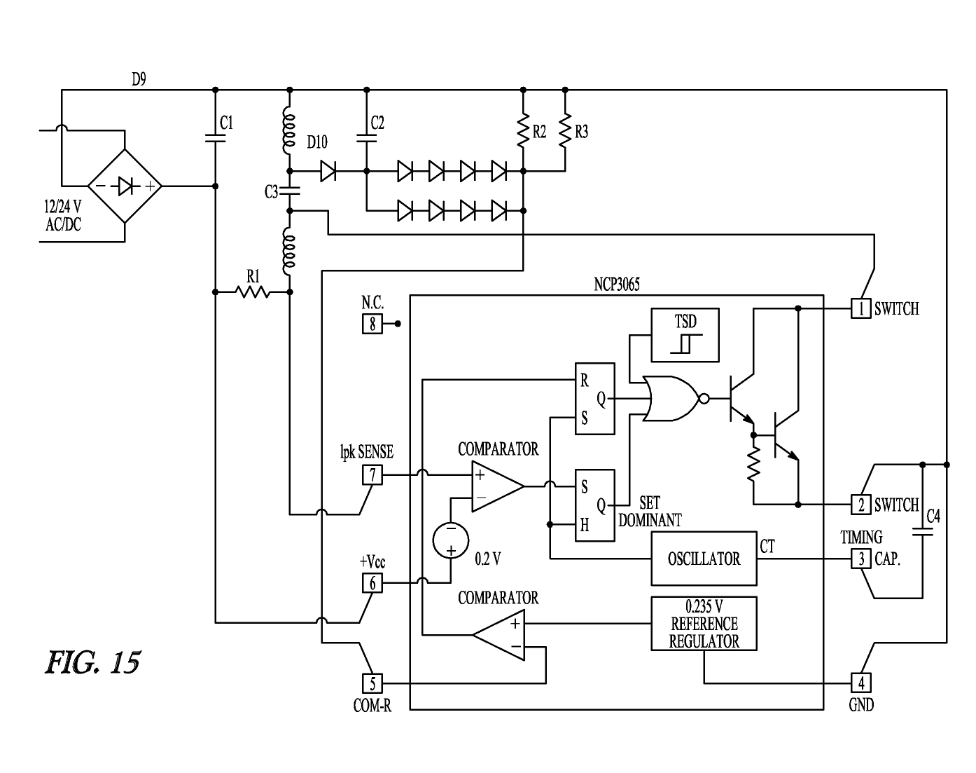

Referring to FIGS. 13-15, an example of the light source unit 10 is schematically and diagrammatically depicted. However, various other designs and configurations of the light source unit 10 are contemplated herein. For instance, although FIG. 13 shows the light source unit 10 as including a rectifier, a light source controller, and one or more light sources, it is contemplated that the controller and/or the rectifier can be eliminated or substituted with another component. Also, while LEDs are shown in FIGS. 14 and 15, other light sources, such as those listed above, can be used in place of or in addition to the LEDs.

The light source unit 10, as described above with respect to both backlit apparatuses 100, 200, in an example, is a universal light source unit 10 that can be used in the above-described backlit apparatuses 100, 200. In other examples, the universal light source unit 10 can be included in various other backlit apparatuses in addition to or instead of the backlit apparatuses 100, 200. In this way, a single configuration of light source unit 10 can be manufactured and used across two or more product lines to save on costs, including design and manufacturing costs. By providing such a universal light source unit 10, backlighting of various devices and apparatuses can be provided in a relatively cost-effective manner.

In an example, a method of cost-effectively providing backlighting to an apparatus includes selecting an apparatus to backlight. The apparatus can be selected from at least a first apparatus and a second apparatus, wherein the first apparatus is configured differently from the second apparatus. In an example, a universal light source unit (for instance, the light source unit 10) is attached within the selected apparatus. In an example, the light source unit is configured to provide backlighting of the selected apparatus. In a further example, the light source unit is configured to universally fit and operate within either of the at least first and second apparatuses. In an example, an apparatus to backlight is selected from the first apparatus including a push switch (for instance, the backlit apparatus 100) or the second apparatus including a touchless switch (for instance, the backlit apparatus 200). In a further example, a light member is attached to the selected apparatus, wherein the light member includes properties configured to transmit light emitted by the light source unit, and wherein the light source unit and the light member are configured to provide the backlighting of the selected apparatus, as described above with respect to apparatuses 100, 200.

In another example, a universal light unit 10 and a light member 104, 204 can be provided to convert an existing non-backlit device to a backlit device.

In still another example, the light source unit 10, in addition to providing backlighting of the apparatus 100, 200, can be used to indicate to the user that the actuation unit 106, 206 has been actuated (for instance, that activation of the touchless switch 206 has been sensed); the end device has been opened, closed, activated, deactivated, etc.; or any other aspect of the operation of the apparatus 100, 200 and/or end device. In some examples, such indications can be made by turning off the one or more of the light sources 12, causing one of more of the light sources 12 to blink (for instance, one blink or a series of blinks), or causing the backlighting to change colors (for instance, from blue to red) by illuminating one or more different light sources 12 or altering a color filter or other such device, for instance. It is also contemplated that audio cues (for instance, a beep) could be used to indicate various information to the user.

The examples described above are advantageous in many respects. For instance, in at least some examples, the apparatuses and methods provide for enhanced ways to call attention to the apparatus and designate the purpose of the apparatus using backlighting. Additionally, the apparatuses and methods provide for manufacturing of such backlit apparatuses in a cost-effective manner so as to not be cost prohibitive to produce. Although various advantages are presented herein, these advantages are not intended to be all inclusive, as further advantages other than those specifically presented herein may become evident.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventor also contemplates examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A backlit apparatus configured to control an end device, the apparatus comprising:
a housing;
an actuation unit attached to the housing, the actuation unit being coupled to the end device and configured to at least partially control the end device;
a light source unit disposed within the housing, the light source unit configured to emit light within the housing; and
a light guide attached to the housing, the light guide including properties configured to transmit the light emitted by the light source unit, wherein the light source unit and the light guide are configured to provide backlighting of the apparatus, the light guide being configured to propagate light in a plurality of modes.

2. The apparatus of claim 1, wherein the properties include at least one of shape and size of the light guide.

3. The apparatus of claim 1, wherein the properties include optical properties of the light guide, wherein the optical properties include at least one of transmittance, haze, and translucency.

4. The apparatus of claim 1, wherein the light guide is configured to emit light of a substantially consistent brightness from a portion of the light guide.

5. The apparatus of claim 1, wherein the light source unit is disposed at least partially around the actuation unit.

6. The apparatus of claim 5, wherein the light source unit is substantially U-shaped.

7. The apparatus of claim 1, wherein the light source unit includes a plurality of light sources attached to a circuit board.

8. The apparatus of claim 1, wherein the actuation unit is a push switch including a push plate adjacent the push switch.

9. A backlit apparatus configured to control an end device, the apparatus comprising:
a housing;
an actuation unit attached to the housing, the actuation unit being coupled to the end device and configured to at least partially control the end device;
a light source unit disposed within the housing, the light source unit configured to emit light within the housing, wherein the light source unit is engaged with the actuation unit; and
a light filter attached to the housing, the light filter including properties configured to transmit the light emitted by the light source unit, wherein the light source unit and the light filter are configured to provide backlighting of the apparatus.

10. The apparatus of claim 9, wherein the properties include at least one of shape and size of the light filter.

11. The apparatus of claim 9, wherein the properties include optical properties of the light filter, wherein the optical properties include at least one of transmittance, haze, and translucency.

12. The apparatus of claim 9, wherein the light source unit is disposed at least partially around the actuation unit.

13. The apparatus of claim 12, wherein the light filter is configured to emit light of a substantially consistent brightness from a portion of the light filter.

14. The apparatus of claim 9, wherein the light source unit includes a plurality of light sources attached to a circuit board.

15. The apparatus of claim 9, comprising an elastic member configured to position the light source unit within the housing.

16. The apparatus of claim 9, wherein the actuation unit includes a touchless switch.

17. The apparatus of claim 9, wherein the light filter includes a recess configured to retain a decal therein, the recess being configured to provide a selected amount of light transmission through the decal to obtain a selected balance between the light transmission through:
the recess and the decal; and
another portion of the light filter.

18. A method of cost-effectively providing backlighting to an apparatus, the method comprising:
selecting an apparatus to backlight, the apparatus selected from at least a first apparatus and a second apparatus, wherein the first apparatus is configured differently from the second apparatus; and
attaching a universal light source unit within the selected apparatus, the light source unit configured to provide backlighting of the selected apparatus, wherein the light source unit is configured to universally fit and operate within either of the at least first and second apparatuses.

19. The method of claim 18, wherein selecting an apparatus to backlight includes selecting either the first apparatus including a push switch or the second apparatus including a touchless switch.

20. The method of claim 18, comprising attaching a light member to the selected apparatus, wherein the light member includes properties configured to transmit light emitted by the light source unit, wherein the light source unit and the light member are configured to provide the backlighting of the selected apparatus.
